(19) United States
(12) Patent Application Publication
(10) Pub. No.: US 2025/0129885 A1
(43) Pub. Date: Apr. 24, 2025

(54) GREASE DISCHARGE DEVICE AND GREASE LUBRICATION SYSTEM

(71) Applicant: MAKITA CORPORATION, Anjo-shi (JP)

(72) Inventors: Satoshi TSUJI, Anjo-shi (JP); Hidefumi HAGIWARA, Anjo-shi (JP); Kazunori KINOSHITA, Anjo-shi (JP)

(73) Assignee: MAKITA CORPORATION, Anjo-shi (JP)

(21) Appl. No.: 18/906,606

(22) Filed: Oct. 4, 2024

(30) Foreign Application Priority Data
Oct. 18, 2023 (JP) 2023-179810
Oct. 18, 2023 (JP) 2023-179811

(51) Int. Cl. F16N 13/06; F16N 39/04

(52) U.S. Cl. CPC F16N 13/06; F16N 39/04; F16N 2013/063

(57) ABSTRACT

A grease discharge device includes a grounded-type tank, a lid, a pump unit, and an attachable and detachable battery. The grounded-type tank is configured to store grease with an opening at an upper part of the tank. The lid closes the opening. The pump unit is connected to the lid. The pump unit suctions the grease in the tank and discharges the grease to an outside of the tank by driving of a motor. The attachable and detachable battery drives the motor.

### CROSS REFERENCE TO RELATED APPLICATION

This application claims the benefit of Japanese Patent Application Numbers 2023-179810 and 2023-179811 filed on Oct. 18, 2023, the entirety of which is incorporated by reference.

### FIELD OF THE INVENTION

The disclosure relates to a grease discharge device that discharges grease stored in a tank and a grease lubrication system in which the grease discharge device is used.

### BACKGROUND OF THE INVENTION

In heavy machinery, such as construction machinery and cranes, a plurality of lubrication points, namely nipples, for maintenance are disposed, and grease is supplied to each lubrication point to appropriately maintain a lubrication state.

As supplying equipment for the grease, there has been known a grease discharge device disclosed in JP 2022-158462 A. The grease discharge device includes a battery-driven motor and a pump that operates by driving of the motor in a main body portion that holds a tank. The tank can house a cartridge filled with grease, and when the motor is driven to operate the pump, the grease in the cartridge is discharged from a discharge port.

The grease discharge device, as disclosed in JP 2022-158462 A, has a battery and can be carried for work by an operator with a shoulder belt fitted to the main body portion. Therefore, the amount of grease filled in the cartridge is reduced to a relatively small amount (for example, 400 g to 500 g) considering the burden on the operator.

However, since heavy machinery has many lubrication points, the grease gets used up with one cartridge, and the cartridge needs to be replaced many times. For example, container cranes have about 100 lubrication points per unit, and 15 to 20 cartridges are replaced and used.

Therefore, it is an object of the disclosure to provide a grease discharge device and a grease lubrication system that can secure a large grease storage amount, and improves ease of handling and is less subject to the restriction of a work area by using a battery.

### SUMMARY OF THE INVENTION

In order to achieve the above-described object, a first configuration of this disclosure is a grease discharge device. The grease discharge device may include a grounded-type tank and a lid. The grounded-type tank is configured to store grease with an opening at an upper part of the tank. The lid closes the opening.

The first configuration may include a pump unit and an attachable and detachable battery. The pump unit is connected to the lid and configured to suction the grease in the tank and discharge the grease to an outside of the tank by driving of a motor. The attachable and detachable battery drives the motor.

In order to achieve the above-described object, a second configuration of this disclosure is a grease discharge device. The grease discharge device may include a grounded-type tank and a pump unit. The grounded-type tank is configured to store grease and having a capacity of 10 liters or more. The pump unit is configured to discharge the grease to an outside of the tank.

The second configuration may include an attachable and detachable battery that drives the pump unit.

In order to achieve the above-described object, a third configuration of this disclosure is a grease lubrication system. The grease lubrication system may include a first grease discharge device that includes a first tank configured to store one liter or less of grease and a first pump driven by a first motor to discharge the grease in the first tank.

The third configuration may include a second grease discharge device that includes a second tank configured to store 10 liters or more of grease and a second pump driven by a second motor to discharge the grease in the second tank.

The third configuration may include a battery configured to feed power selectively to the first motor or the second motor.

With the disclosure, a large grease storage amount can be secured. In addition, since the motor that activates the pump is driven by the battery, a power supply cord and an air hose are not required, improving ease of handling and becoming less subject to the restriction of a work area.

### BRIEF DESCRIPTION OF THE DRAWINGS

FIG. 1 is a perspective view of a grease discharge device of Embodiment 1.

FIG. 2A is an explanatory view of the grease discharge device of Embodiment 1, illustrating a side view thereof.

FIG. 2B is an explanatory view of the grease discharge device of Embodiment 1, illustrating a plan view thereof.

FIG. 2C is an explanatory view of the grease discharge device of Embodiment 1, illustrating a front view thereof.

FIG. 2D is an explanatory view of the grease discharge device of Embodiment 1, illustrating a back view thereof.

FIG. 3 is an enlarged cross-sectional view taken along the line A-A in FIG. 2C.

FIG. 4 is a perspective view of a grease discharge device with the number of battery packs changed.

FIG. 5A is an explanatory view of the grease discharge device in FIG. 4, illustrating a side view thereof.

FIG. 5B is an explanatory view of the grease discharge device in FIG. 4, illustrating a plan view thereof.

FIG. 5C is an explanatory view of the grease discharge device in FIG. 4, illustrating a front view thereof.

FIG. 5D is an explanatory view of the grease discharge device in FIG. 4, illustrating a back view thereof.

FIG. 6 is an enlarged cross-sectional view taken along the line B-B in FIG. 5C.

FIG. 7 is a perspective view of a grease discharge device with a pump unit changed.

FIG. 8A is an explanatory view of the grease discharge device in FIG. 7, illustrating a side view thereof.

FIG. 8B is an explanatory view of the grease discharge device in FIG. 7, illustrating a plan view thereof.

FIG. 8C is an explanatory view of the grease discharge device in FIG. 7, illustrating a front view thereof.

FIG. 8D is an explanatory view of the grease discharge device in FIG. 7, illustrating a back view thereof.

FIG. 9 is an enlarged cross-sectional view taken along the line C-C in FIG. 8C.

FIG. 10 is a perspective view of a grease discharge device of Embodiment 2.

FIG. 11A is an explanatory view of the grease discharge device of Embodiment 2, illustrating a side view thereof.

FIG. 11B is an explanatory view of the grease discharge device of Embodiment 2, illustrating a cross-sectional view taken along the line D-D of FIG. 11A.

FIG. 12A is an explanatory view of a grease discharge device in which electric heaters are disposed, illustrating a side view thereof.

FIG. 12B is an explanatory view of the grease discharge device in which electric heaters are disposed, illustrating a cross-sectional view taken along the line E-E of FIG. 12A.

FIG. 13 is a perspective view from a rear of a state where a tank and a case are omitted from the grease discharge device in which the electric heaters are disposed.

FIG. 14A is an explanatory view of a grease discharge device with the number of cartridges changed, illustrating side view thereof.

FIG. 14B is an explanatory view of the grease discharge device with the number of cartridges changed, illustrating a cross-sectional view taken along the line F-F of FIG. 14A.

FIG. 15 is a perspective view of a grease discharge device in which a cartridge is not used.

FIG. 16A is an explanatory view of the grease discharge device of FIG. 15, illustrating a side view thereof.

FIG. 16B is an explanatory view of the grease discharge device of FIG. 15, illustrating a cross-sectional view taken along the line G-G of FIG. 16A.

FIG. 17A is an explanatory view of a grease discharge device with the number of battery packs changed, illustrating a side view thereof.

FIG. 17B is an explanatory view of the grease discharge device with the number of battery packs changed, illustrating a cross-sectional view taken along the line H-H of FIG. 17A.

FIG. 18 is a schematic diagram illustrating a modification example of a layout of a pump unit and a battery pack.

FIG. 19 is a schematic diagram illustrating a modification example of the layout of the pump unit and the battery pack.

FIG. 20 is an explanatory view of a grease lubrication system.

### DETAILED DESCRIPTION OF THE INVENTION

In one embodiment of the disclosure, a battery may be disposed on an upper surface of a lid.

With the configuration, the battery can be arranged without protruding outside a tank, and the battery does not hinder work.

In one embodiment of the disclosure, a plurality of batteries may be disposed.

With the configuration, a long period of continuous use is enabled, reducing the interruption of work due to battery replacement and the like.

In one embodiment of the disclosure, the tank may include a moving unit.

With the configuration, the tank can be easily moved.

In one embodiment of the disclosure, the moving unit may have a tire.

With the configuration, the tank is moved more easily, and a moving direction can be easily changed.

In one embodiment of the disclosure, the moving unit may include a handle.

With the configuration, the moving unit can be easily operated.

In one embodiment of the disclosure, the handle may be adjustable in height.

With the configuration, an operator can easily operate the moving unit.

In one embodiment of the disclosure, the moving unit may be a plurality of casters disposed on a bottom surface of the tank.

With the configuration, the moving unit can be formed compactly.

In one embodiment of the disclosure, an operation portion that turns on or off the driving of a motor may be included, and a first coupler or a second coupler may be selectively connectable to a discharge port of a pump unit. The first coupler is connectable to a grease supply destination, and the second coupler includes a second operation portion that controls the motor and is connectable to a grease supply destination.

With the configuration, the operation portion with the first coupler or the second operation portion with the second coupler can be selected and used according to a work area, contributing to the improvement of workability.

In one embodiment of the disclosure, the second operation portion may include at least a switch that turns on or off the driving of the motor and an operating member that operates the switch.

With the configuration, it is possible to switch whether grease is discharged or not simply by operating the operating member, improving usability.

In one embodiment of the disclosure, the second operation portion may have a speed change operation portion that can change a rotation speed of the motor.

With the configuration, a discharge amount of grease can be easily changed by operating the speed change operation portion.

In one embodiment of the disclosure, the tank may be circular in plan view and have a capacity of at least 16 liters.

With the configuration, a storage amount of grease can be secured in large amounts, making it less likely to use up the grease even if there are many lubrication points.

In one embodiment of the disclosure, a display part that displays at least a remaining capacity of the battery may be included.

With the configuration, the battery can be replaced or charged before the battery runs out, making it less likely to cause the interruption of work for a long period of time.

In one embodiment of the disclosure, the battery may be covered with a cover.

With the configuration, grease sticking to the battery can be avoided.

In one embodiment of the disclosure, a heating unit for grease may be disposed on the tank.

With the configuration, since the grease does not become hard even when the temperature of a working environment is low, deterioration of workability due to poor discharge can be avoided.

Embodiment 1 of the disclosure is described below based on the drawings.

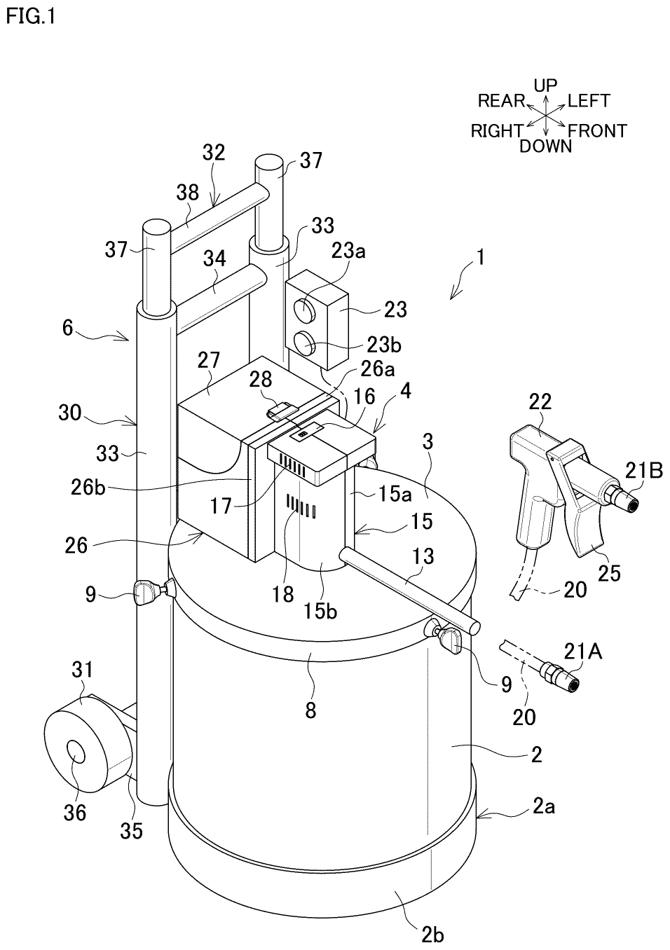

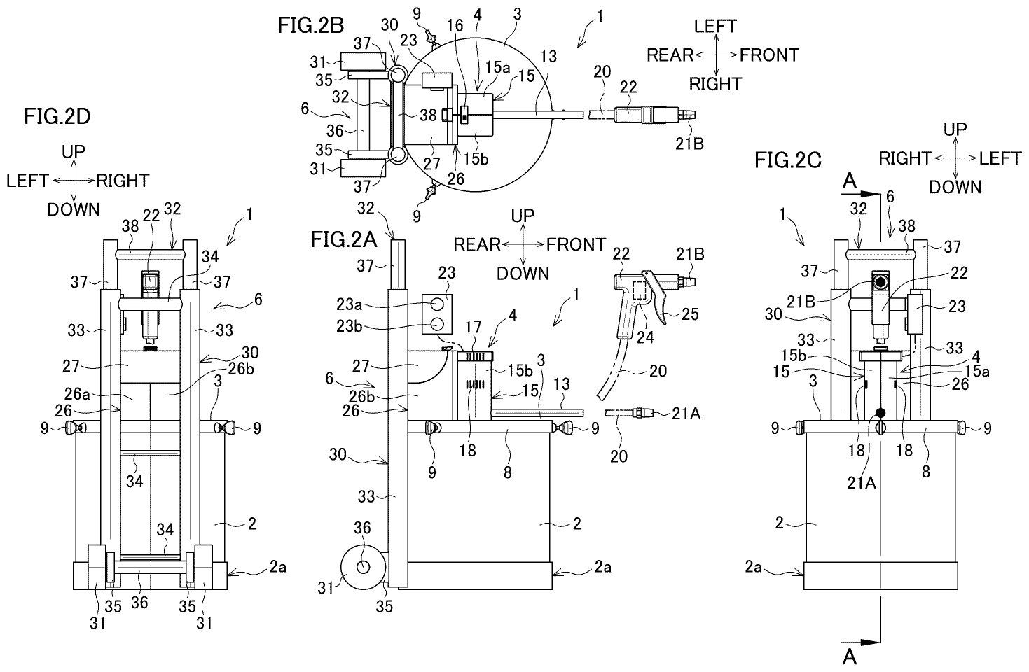

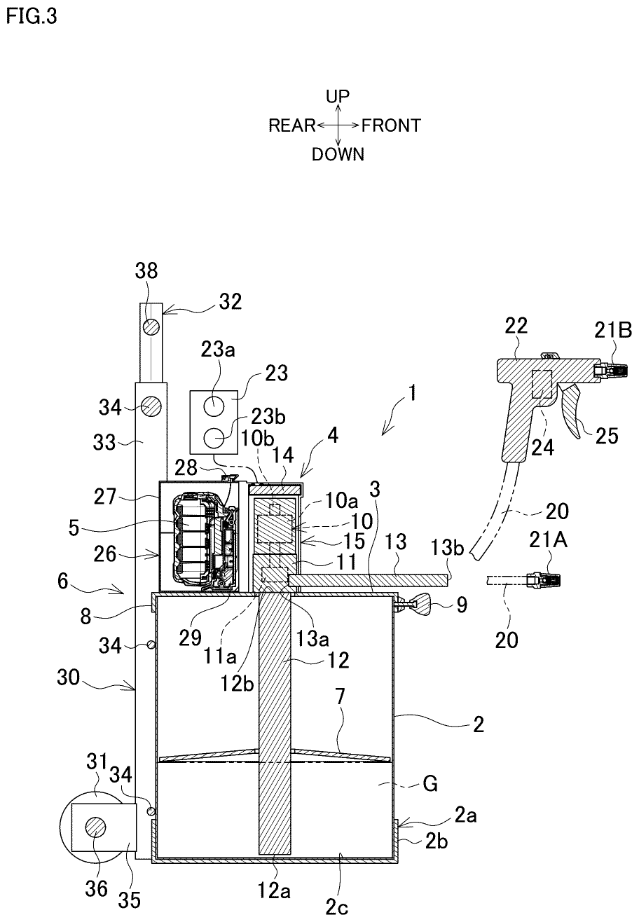

FIG. 1 is a perspective view illustrating an exemplary grease discharge device of the disclosure. FIG. 2A, FIG. 2B, FIG. 2C, and FIG. 2D are a side view, a plan view, a front view, and a back view of the grease discharge device, respectively. FIG. 3 is a cross-sectional view taken along the line A-A in FIG. 2C.

A grease discharge device 1 includes a tank 2, a lid 3, a pump unit 4, a battery pack 5, and a carrier 6.

The tank 2 has a circular shape in plan view that stores grease by opening an upper surface. The tank 2 has a capacity of, for example, 16 liters, which is greater than the capacity of a conventional portable cartridge. A pail can or a drum can is used for the tank 2. For example, in the case of a pail can, the capacity can be 18 liters or 20 liters. For example, in the case of a drum can, the capacity can be about 200 liters. In both cases, the capacity can be arbitrarily determined between 15 liters and 250 liters.

An inner lid 7 is disposed inside the tank 2. The inner lid 7 has a conical shape, whose center is penetrated by a suction pipe 12 described later of the pump unit 4, and is placed on an upper surface of the grease to be stored. The inner lid 7 is disposed, thereby reducing air mixing into the grease. The inner lid 7 has a lower surface in contact with at least a part of an upper surface of grease G. When an amount of the grease G decreases, the inner lid 7 moves downward.

The tank 2 is held directly in a tank holder 2a by being placed in the tank holder 2a opening upward from above the tank holder 2a. The tank 2 held in the tank holder 2a is restricted from moving from front to rear and from side to side by a peripheral wall 2b of the tank holder 2a. In addition, the tank 2 held in the tank holder 2a is restricted from moving downward by a lower surface 2c of the tank holder 2a. By using the tank holder 2a, the obtained pail can or drum can can be used directly.

The lid 3 has a circular shape in plan view that closes the upper surface of the tank 2. A peripheral edge portion 8 that covers an upper outer periphery of the tank 2 is disposed on an outer periphery of the lid 3. Three hand screw 9 are disposed at equal intervals in a circumferential direction on the peripheral edge portion 8. The hand screws 9 fix the lid 3 to the tank 2 by pressing the upper outer periphery of the tank 2 by threading operation. The lid 3 makes it hard for dust, waste, and the like to enter the tank 2. Another member other than hand screws can be employed as a fixing unit of the lid 3. For example, a latch can be used or a positive lock structure can be used.

The pump unit 4 is connected to the lid 3. The connection is performed by fixing with screws or by fixing through welding. The pump unit 4 includes a motor 10, a pump portion 11, the suction pipe 12, a discharge pipe 13, and a controller 14.

The motor 10 is arranged on an upper side in a case 15 disposed upright in an up-down direction at the center of an upper surface of the lid 3. The case 15 is formed by fixing a left case 15a and a right case 15b with a screw. The motor 10 is an inner rotor-type brushless motor. The brushless motor is formed by arranging a rotor 10b inside a cylindrical stator 10a. The stator 10a has a stator core, an insulator, and a coil. The rotor 10b has a rotor core and a magnet. The brushless motor also includes three magnetic sensors that detect the rotation of the rotor 10b.

The pump portion 11 is arranged on a lower side of the motor 10 in the case 15 and includes a fan, namely impeller, 11a that rotates by driving of the motor 10. The fan 11a is arranged at a lower portion of the motor 10.

The suction pipe 12 is connected to a suction side of the fan 11a at a lower portion of the pump portion 11, penetrates the center of the lid 3, and has a lower end extending close to a bottom surface of the tank 2. The suction pipe 12 has a length approximately the same as a length in the up-down direction of the tank 2. The suction pipe 12 has a suction opening 12a, which is a grease inlet, at the lower end, and a connection port 12b, which is a grease outlet, at an upper end. The connection port 12b is connected to the pump portion 11.

The discharge pipe 13 is connected to a discharge side of the fan 11a on a front surface of the pump portion 11, penetrates the case 15, and extends forward. The discharge pipe 13 has an inlet 13a for grease at a rear end and a discharge port 13b, which is a grease outlet, at a front end. The inlet 13a is connected to the pump portion 11, and the discharge port 13b is connected to a flexible hose 20 described later.

The controller 14 is housed in an upper portion of the case 15 on an upper side of the motor 10. The controller 14 obtains power source from the battery pack 5 and supplies electric power to the motor 10. A display part 16 disposed on an upper surface of the controller 14 is exposed on an upper surface of the case 15. The display part 16 displays a remaining capacity of the battery pack 5. The display part 16 is sandwiched between the left case 15a and the right case 15b and fixed by the two. An air inlet 17 is formed on the upper portion of the case 15 that is a surface of the case 15 on the right side of the controller 14. An exhaust outlet 18 is formed in a middle portion of the case 15 that is a surface of the case 15 on the right side of the motor 10. When a fan disposed on a rotation shaft (not illustrated) of the motor 10 rotates, air suctioned in from the air inlet 17 passes through the controller 14 and the motor 10 in turn to cool each of them and then is discharged from the exhaust outlet 18.

A coupler 21A or a switch trigger 22 is selectively connectable to a distal end of the discharge pipe 13 each via the flexible hose 20. FIG. 1 to FIG. 3 illustrate both of them. If necessary, the discharge pipe 13 may be bifurcated such that both the coupler 21A and the switch trigger 22 are connected to the discharge pipe 13.

The coupler 21A is connectable to a lubrication point of heavy machinery and the like. When the coupler 21A is connected, a switch 23 is used. The switch 23 includes an ON button 23a and an OFF button 23b and is electrically connected to the controller 14 via a cord indicated by a two-dot chain line. Pressing the ON button 23a outputs an ON signal to the controller 14, and pressing the OFF button 23b outputs an OFF signal to the controller 14.

When the controller 14 obtains the ON signal by the pressing operation of the ON button 23a, it drives the motor 10 to activate the pump portion 11. When the controller 14 obtains the OFF signal by the pressing operation of the OFF button 23b, it stops driving of the motor 10 to deactivate the pump portion 11. When the controller 14 obtains the ON signal, it rotates the motor 10 at full speed. When the controller 14 obtains the OFF signal, it turns the rotation of the motor 10 to zero. The switch 23 can be used by being placed on the upper surface of the lid 3, suspended in a suitable location within reach of an operator, or carried by the operator.

Thus, since the switch 23 is disposed as a separate body separately from the coupler 21A, the pump portion 11 can be activated/deactivated without the operator being near the heavy machinery.

The switch 23 can also be fixed directly or indirectly to the case 15. In this case, it is only necessary to perform the pressing operation of the ON button 23a and the OFF button 23b of the switch 23 fixed to the case 15 after the coupler 21A is connected to a lubrication point.

Furthermore, the maximum rotation speed of the motor 10 can be set in a plurality of stages in advance. For example, the maximum rotation speed can be set to three stages, such as low speed, medium speed, and high speed. In a case where the setting is conducted, when the ON signal is received, the motor 10 rotates at low speed under the low speed setting, the motor 10 rotates at medium speed under the medium speed setting, and the motor 10 rotates at high speed under the high speed setting. Of course, the maximum rotation speed is not limited to three stages and can be set to four or more stages.

The switch trigger 22 includes a coupler 21B at a distal end. The coupler 21B has the same shape as the coupler 21A and is connectable to a lubrication point of heavy machinery and the like. The switch trigger 22 includes a switch 24 and a trigger 25 that operates the switch 24 and is electrically connected to the controller 14 via a cord (not illustrated) along the flexible hose 20. When the trigger 25 is operated by pushing, the switch 24 is turned on, and the controller 14 drives the motor 10 to activate the pump portion 11. The controller 14 is configured to increase the rotation speed of the motor 10 according to an increase in a push-in amount of the trigger 25 to increase a discharge amount of grease from the pump portion 11. Thus, since the rotation speed of the motor 10 is set according to the push-in amount of the trigger 25, the configuration is suitable for lubricating the amount deemed necessary by an operator. When the push-in of the trigger 25 is released to turn the switch 24 off, the controller 14 stops driving of the motor 10 to deactivate the pump portion 11.

It should be noted that the motor 10 can be rotated at full speed by pushing the trigger 25. In this case, similarly to the switch 23, the maximum rotation speed can be preset in a plurality of stages.

The battery pack 5 is connected to a battery base 26 fixed to the upper surface of the lid 3. The battery base 26 is formed by fixing a left base 26a and a right base 26b with a screw. A battery connector 29 is tucked and fixed in a seam between the left base 26a and the right base 26b. The battery pack 5 is the same as that used for electric power tools, and for example, that with a rated voltage of 36 V is used. The battery pack 5 engages with the battery connector 29. The battery connector 29 is electrically connected to the controller 14 via a cord (not illustrated). The battery pack 5 can supply electric power to the controller 14 via the battery connector 29 by engaging with the battery connector 29. The battery pack 5 is fixed to the lid 3 via the battery base 26 by being connected to the battery base 26.

The battery base 26 has a square shape in plan view that is fixed to the upper surface of the lid 3. Respective parts of an upper surface, right and left side surfaces, and a rear surface of the battery base 26 form an integral opening and closing cover 27. The opening and closing cover 27 has a lower end of the rear surface joined with a hinge and is openable/closable in the up-down direction with the hinge as an axis by a latch 28 disposed at a front end of the upper surface.

When the opening and closing cover 27 is closed in a state where the battery pack 5 engages with the battery connector 29, the battery pack 5 is fully covered with the battery base 26 and the opening and closing cover 27. Therefore, the influence of factors outside the battery base 26 and the opening and closing cover 27 on the battery pack 5 can be reduced to be low.

The carrier 6 includes a frame 30, two tires 31 and a handle 32.

The frame 30 includes a right and left pair of support pillars 33 and a plurality of coupling rods 34. The right and left support pillars 33 are fixed in the up-down direction to a rear surface of the tank 2. The coupling rods 34 are installed in a right-left direction between the support pillars 33. A right and left pair of brackets 35 projecting rearward are disposed at lower portions of the support pillars 33.

The tires 31 are attached to both right and left ends of a shaft 36 that penetrates the brackets 35 in the right-left direction. The tires 31 are grounded in a similar manner in a state where the tank 2 is grounded.

The handle 32 is composed of a right and left pair of vertical bars 37 projecting from the right and left support pillars 33 and a horizontal bar 38 coupling respective upper ends of the vertical bars 37. The vertical bars 37 are movable in the up-down direction with respect to the support pillars 33 and fixable in a predetermined position by a fixing unit, for example, a hand screw (not illustrated). Accordingly, the horizontal bar 38 is adjustable in height.

The grease discharge device 1 configured as described above can discharge grease from the coupler 21A or 21B in a state where a predetermined amount of grease is stored in the tank 2 and the battery pack 5 is fitted to the battery connector 29 in the battery base 26. Specifically, when an operator performs the pressing operation of the ON button 23a of the switch 23 or pushing operation of the trigger 25 in a state where the coupler 21A or 21B is connected to a lubrication point of heavy machinery and the like, the controller 14 drives the motor 10. Then, the pump portion 11 of the pump unit 4 is activated to suction the grease in the tank 2 from the suction pipe 12 and discharge the grease from the discharge pipe 13. The discharged grease is discharged from the coupler 21A or 21B via the flexible hose 20 and supplied to the lubrication point. When the pressing operation of the OFF button 23b of the switch 23 is performed or the pushing operation of the trigger 25 is released, the driving of the motor 10 is stopped to stop discharging the grease.

When the grease discharge device 1 is moved, the horizontal bar 38 of the handle 32 is gripped to pull down the carrier 6 rearward together with the tank 2. Then, the tank 2 rises up from the ground while the tires 31 remain grounded. Accordingly, the operator can directly move the grease discharge device 1 to any location by the carrier 6. In particular, while a pail can weighs about 20 kg, and a drum can weighs about 200 kg, both can be easily moved by the tires 31.

When a pail can or a drum can is not used directly, grease is transferred from the pail can or the like to the tank 2. In this case, the hand screws 9 are loosened, and the lid 3 is removed from the tank 2. Then, the pump unit 4 and the battery base 26 integrated with the lid 3 are also removed simultaneously. Accordingly, the grease can be supplied into the tank 2 from the opened upper surface.

Thus, the grease discharge device 1 of the above-described Embodiment 1 according to a first configuration of the disclosure includes the grounded-type tank 2, the lid 3, the pump unit 4, and an attachable and detachable battery pack 5, namely an exemplary battery. The grounded-type tank 2 is configured to store grease by opening the upper surface. The lid 3 closes the upper surface of the tank 2. The pump unit 4 is connected to the lid 3, suctions grease in the tank 2 and discharges the grease to an outside by driving of the motor 10. The attachable and detachable battery pack 5 drives the pump unit 4.

With the configuration, a large grease storage amount can be secured by the grounded-type tank 2. In addition, since the motor 10 that activates the pump unit 4 is driven by the battery pack 5, a power supply cord and an air hose are not required, improving ease of handling and becoming less subject to the restriction of a work area.

The battery pack 5 is disposed on the upper surface of the lid 3.

Accordingly, the battery pack 5 can be arranged without protruding outside the tank 2, and the battery pack 5 does not hinder work.

The tank 2 includes the carrier 6, namely an exemplary moving unit.

Accordingly, the tank 2 can be easily moved.

The carrier 6 includes the tires 31.

Accordingly, the tank 2 is moved more easily, and a moving direction can be easily changed.

The carrier 6 includes the handle 32.

Accordingly, the carrier 6 can be easily operated.

The handle 32 is adjustable in height.

Accordingly, an operator can easily operate the carrier 6.

The ON button 23a and the OFF button 23b, namely an exemplary operation portion, which turn on or off the driving of the motor 10 are included, and the coupler 21A, namely an exemplary first coupler, or the coupler 21B, namely an exemplary second coupler, is selectively connectable to the discharge port 13b of the pump unit 4. The coupler 21A is connectable to a grease supply destination, and the coupler 21B includes the switch trigger 22, namely an exemplary second operation portion, which controls the motor 10, and is connectable to a grease supply destination.

Accordingly, the coupler 21A with the switch 23 or the switch trigger 22 can be selected and used according to a work area, contributing to the improvement of workability.

The switch trigger 22 includes the switch 24 that turns on or off the driving of the motor 10 and the trigger 25, namely an exemplary operating member, which operates the switch 24.

Accordingly, it is possible to switch whether grease is discharged or not simply by operating the trigger 25, improving usability.

The switch trigger 22 has the trigger 25, namely an exemplary speed change operation portion, which can change the rotation speed of the motor 10.

Accordingly, the discharge amount of grease can be easily changed by adjusting the push-in amount of the trigger 25.

The tank 2 is circular in plan view and has a capacity of at least 16 liters.

Accordingly, the storage amount of grease can be secured in large amounts, making it less likely to use up the grease even if there are many lubrication points.

The display part 16 that displays the remaining capacity of the battery pack 5 is included.

Accordingly, the battery pack 5 can be replaced or charged before the battery runs out, making it less likely to cause the interruption of work for a long period of time.

The battery pack 5 is covered with the battery base 26 and the opening and closing cover 27, namely an exemplary cover.

Accordingly, grease sticking to the battery connector 29 and the battery pack 5 can be avoided.

The following describes a modification example of Embodiment 1.

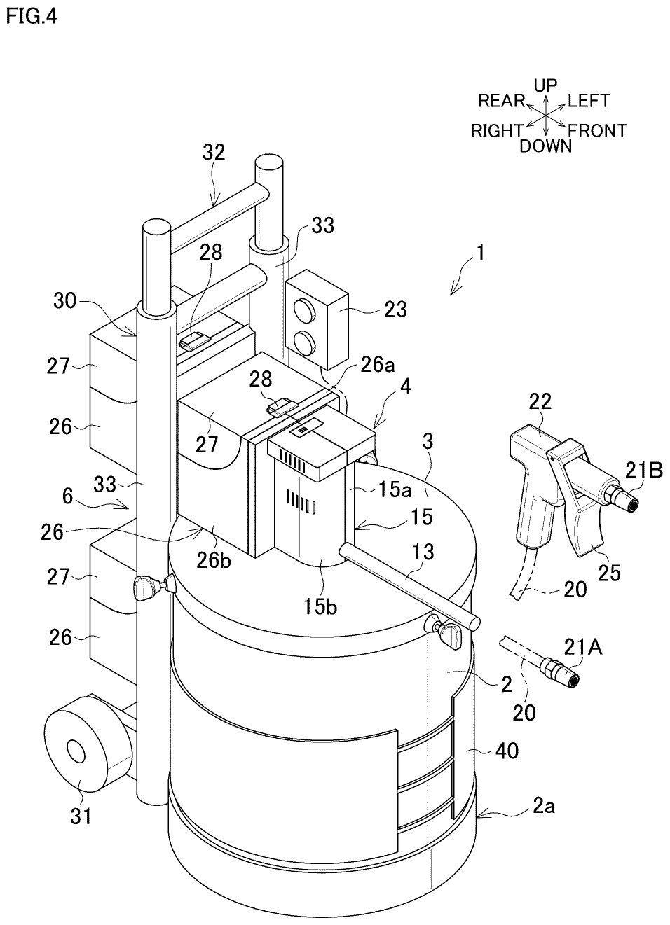

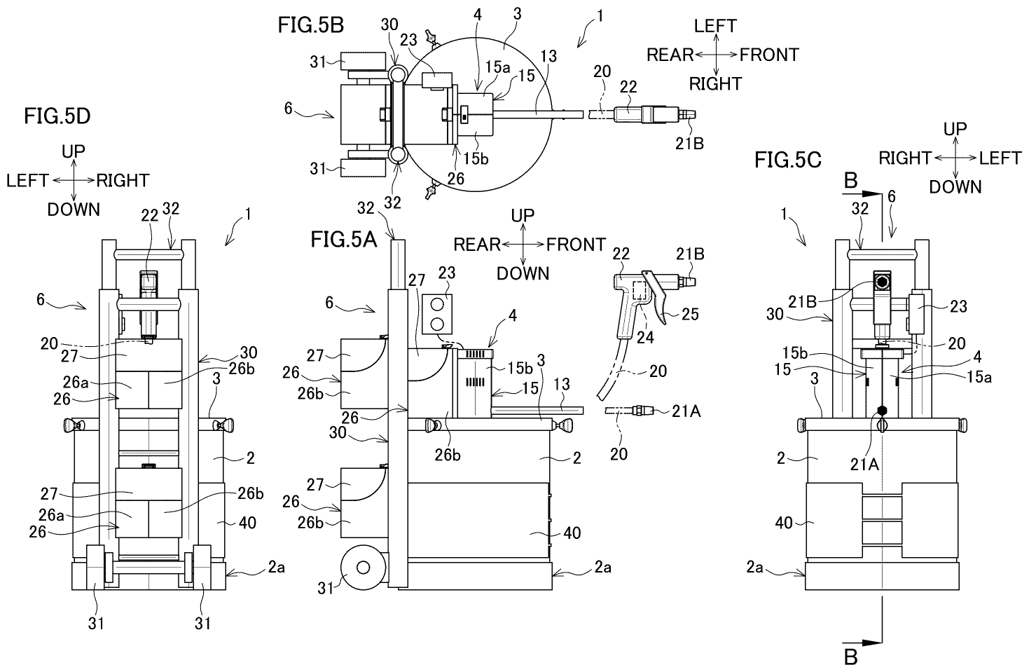

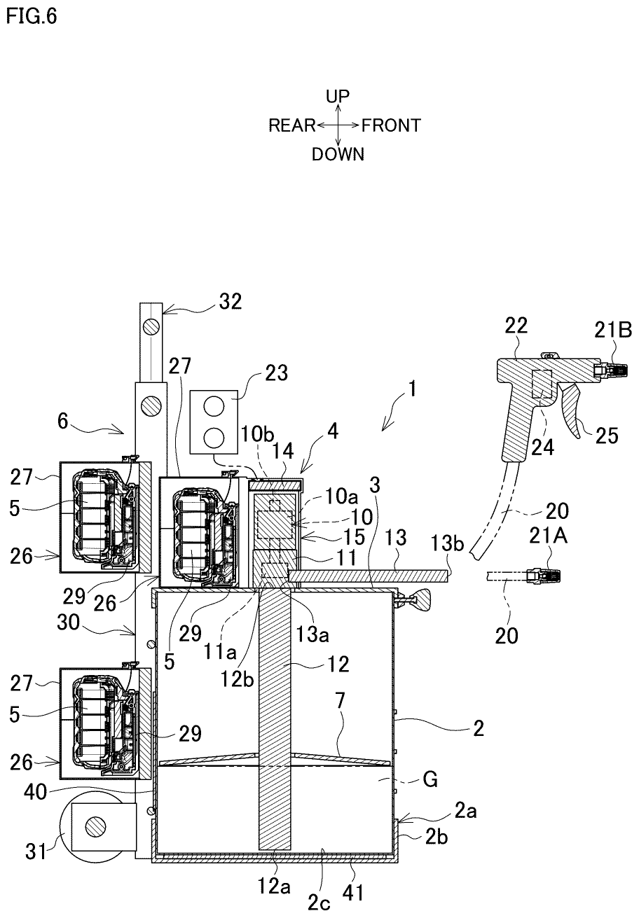

A plurality of battery packs may be disposed without limiting to one battery pack. FIG. 4, FIGS. 5A to 5D, and FIG. 6 illustrate an example in which three battery packs 5 are disposed. One battery pack 5 is disposed on the upper surface of the lid 3 in the same manner as in FIG. 1 to FIG. 3. The other two battery packs 5 are disposed up and down on a rear side of the frame 30 of the carrier 6. In this case, each of the upper and lower battery packs 5 is also fitted to the battery connector 29 in each battery base 26 attached to a rear surface of the frame 30 and fully covered with the battery base 26 and the opening and closing cover 27. The three battery packs 5 are connected in parallel and used by the controller 14 one by one in turn. However, two or three battery packs 5 may be connected in series and used simultaneously.

Thus, when a plurality of battery packs 5 are disposed, a long period of continuous use is enabled, reducing the interruption of work due to replacement and the like of the battery pack 5.

The number and arrangement of battery packs can be appropriately changed without limiting to an example in FIG. 4 to FIG. 6. For example, the battery pack at the upper portion of a lid may be eliminated, and only two battery packs on a rear side of a frame may be disposed. Only any one of the upper and lower battery packs may be disposed on the rear side of the frame.

All the rated voltages of the battery packs need not be the same.

When the temperature of a working environment is low, for example, when it is in winter or when a work area is in a cold weather region, grease may become hard and difficult to discharge. Therefore, a heating unit for grease is preferably disposed on a tank.

FIG. 4 to FIG. 6 illustrate an example in which an electric heater as an exemplary heating unit is disposed on the tank. Here, a first electric heater 40 is disposed on a peripheral surface of the tank 2, and a second electric heater 41 is disposed on the bottom surface of the tank 2. Each of the electric heaters 40, 41 has a configuration in which heating wires are arranged in a planar manner, such as a meandering manner, in a flexible sheet, generates heat by energization by the controller 14, and heats an outer surface of the tank 2. The first electric heater 40 has a strip shape having a predetermined width in the up-down direction and wound around the peripheral surface of the tank 2. The second electric heater 41 has a circular shape in plan view interposed between the tank holder 2a, which covers a bottom portion of the tank 2 from below the tank 2 and the bottom surface of the tank 2. Both electric heaters 40, 41 may be energized simultaneously with when the switches 23, 24 are turned on, and a separate switch that selects the energization to both electric heaters 40, 41 may be disposed in the case 15. The battery pack 5 that drives the pump portion 11 is a power source for the electric heaters 40, 41. However, respective different power sources, namely respective different battery packs when a plurality of battery packs are disposed, may feed power to the electric heaters 40, 41 and the pump portion 11.

When the first and second electric heaters 40, 41 are thus disposed, the tank 2 can be heated from the outside to warm up grease. Accordingly, since the grease does not become hard even when the temperature of a working environment is low, deterioration of workability due to poor discharge can be avoided.

Not both, but only any one of first and second electric heaters may be disposed. A configuration of the electric heater itself can be changed appropriately. The number of electric heaters may be increased. The electric heater can also be disposed inside the tank.

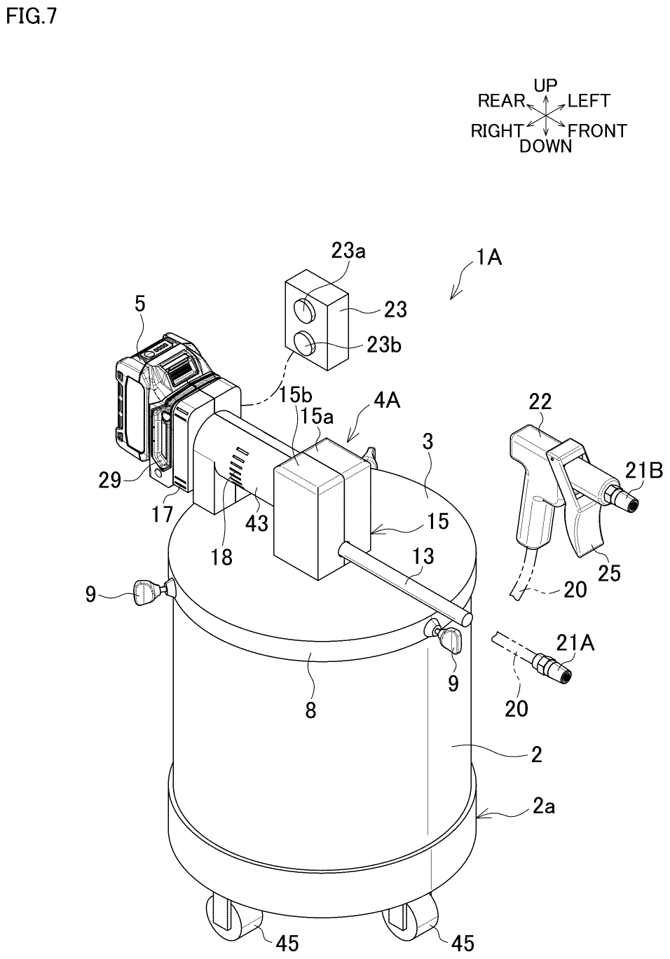

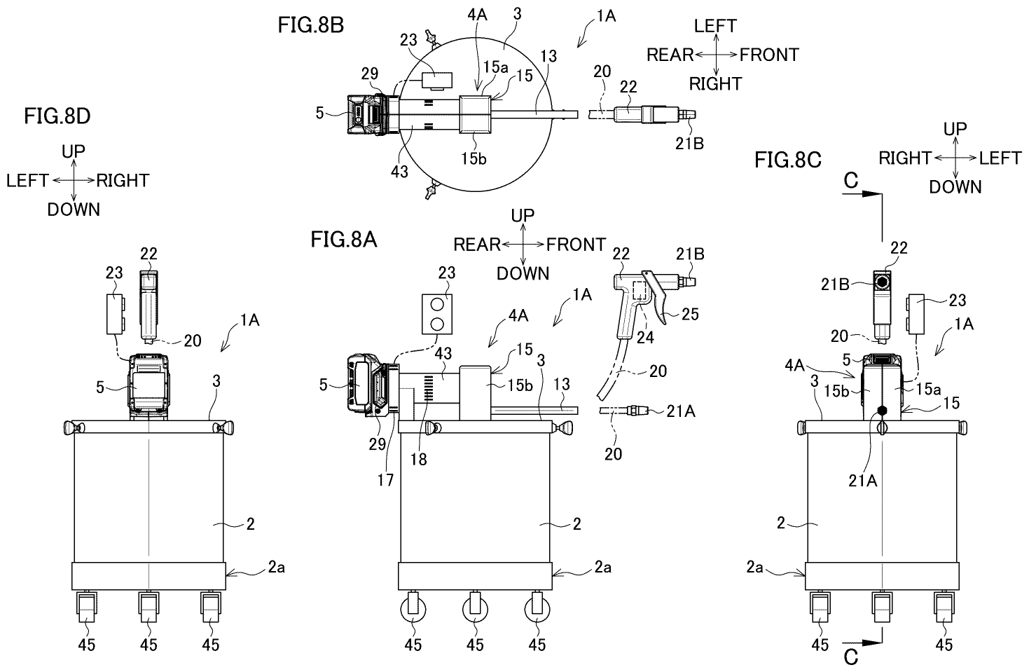

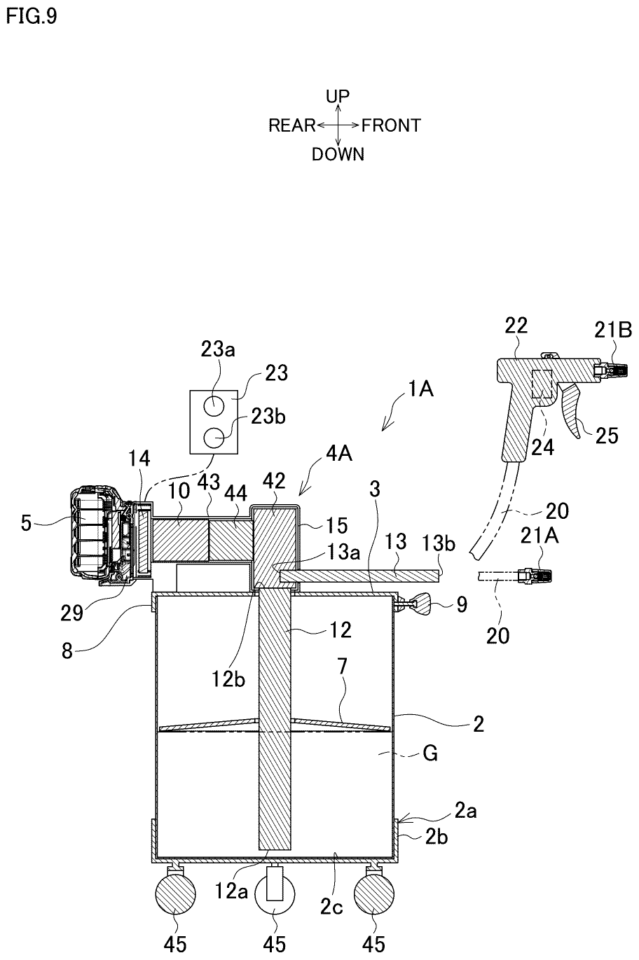

The configuration of a pump unit can also be changed appropriately. FIG. 7, FIGS. 8A to 8D, and FIG. 9 illustrate an exemplary grease discharge device with the pump unit changed. In a grease discharge device 1A, a pump unit 4A includes inside the case 15 a plunger-type pump portion 42 that suctions grease by moving a plunger up and down by a crank mechanism as disclosed in JP 2022-158462 A instead of a pump portion in which a fan is used. The case 15 includes a projecting portion 43 extending rearward. In the projecting portion 43, a gear portion 44, the motor 10, and the controller 14 are arranged in this order from a front, and the battery connector 29 is disposed at a rear end of the projecting portion 43. When the motor 10 is driven, the plunger of the pump portion 42 moves up and down via the gear portion 44, suctioning grease from the suction pipe 12.

In the grease discharge device 1A, an orientation of the projecting portion 43 is not limited to rearward, but the projecting portion 43 may project in the right-left direction or project upward. A battery base that covers the battery pack 5 as illustrated in FIG. 1 may be disposed at an end portion of the projecting portion 43. When the projecting portion 43 projects upward, the battery connector 29 and the battery pack 5 do not protrude outside from the tank 2 in plan view, making it compact in a front-rear direction.

In another configuration, the pump unit 4A can be arranged within a range of an outer diameter of the tank 2. For example, the center of a front-rear length of the pump unit 4A and the battery pack 5 in FIG. 7 may be aligned with the center of a front-rear length of the tank 2.

FIG. 7 to FIG. 9 also illustrate a modification example of a moving unit. Here, instead of a carrier, a plurality of casters 45 are disposed on the bottom surface of the tank 2 to be movable.

Thus, when the moving unit is made of the plurality of casters 45 disposed on the bottom surface of the tank 2, the moving unit can be formed compactly.

A stopper may also be disposed in the casters 45. In addition, a handle may be disposed on the upper surface of the lid 3. As illustrated in FIG. 4, the first and second electric heaters 40, 41 may be disposed on the tank 2.

In common among the above-described Embodiment 1 and respective modification examples, the following changes can be further made.

The capacity of the tank is not limited to 16 liters. Even a grease discharge device according to a second configuration of the disclosure, which includes a tank having a capacity of 10 liters or more, a pump unit that suctions grease in the tank and discharges the grease to an outside by driving of a motor, and an attachable and detachable battery that drives the pump unit, can be preferably used for heavy machinery with a lot of lubrication points. The tank is not limited to being circular in plan view. The tank may have another shape in plan view, such as an ellipse, a square, or a polygon.

The lid is not limited to a structure that can be removed from the tank but may be joined to be openable/closable by a hinge. A grease replenishing opening may be provided in the lid or the tank.

The speed change operation portion that changes the rotation speed of the motor is not limited to a trigger of a switch trigger. Another speed change operation portion, such as a dial, may be disposed as a speed change operation portion. It is not necessary to have a speed change operation portion.

In each example described above, while the first coupler with the switch or the switch trigger is selectively connected, only any one of them may be connected.

The switches and the controller may be able to communicate wirelessly instead of by wire.

The battery is not limited to a battery pack for electric power tools. The configuration and the rated voltage may be changed appropriately.

The configuration of the battery base can also be changed appropriately. The opening and closing cover may be omitted in the examples of FIG. 1 to FIG. 6.

The moving unit may be omitted, and the tank may be directly placed on the ground for use.

The display part is not limited to displaying the remaining capacity of the battery but can display other information. For example, it is possible to display the amount of grease lubricated to the lubricating point from when the switch is turned on to when it is turned off. In addition, a sensor that detects the temperature and the storage amount of grease in the tank can be disposed to display the temperature and the remaining amount of the grease detected by the sensor. An inspection hole may be disposed in the tank to grasp the remaining amount of the grease.

The controller may be equipped with an AC/DC converter to allow a power supply cord to be connected such that the controller can be used with a commercial power source.

Next, Embodiment 2 of the disclosure is described.

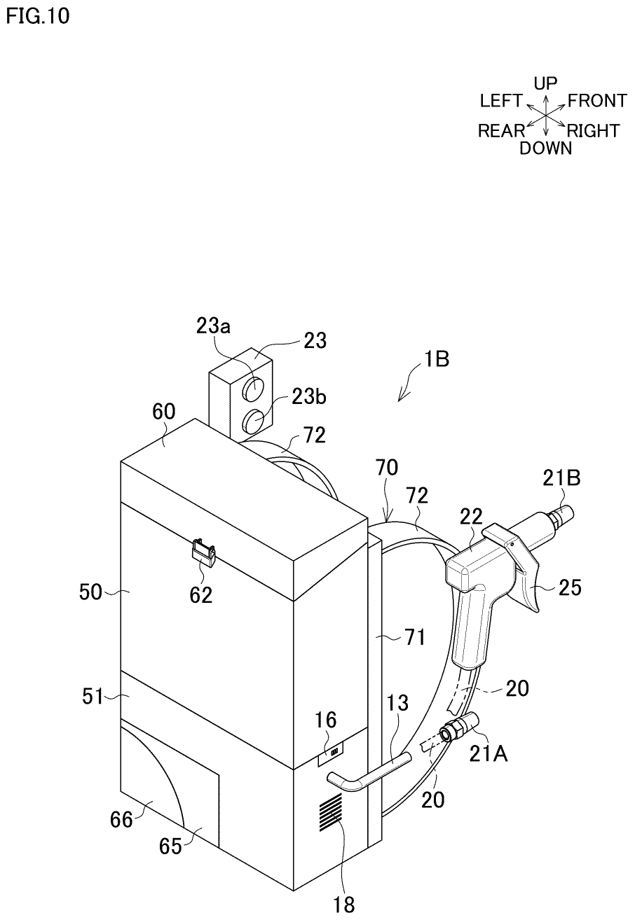

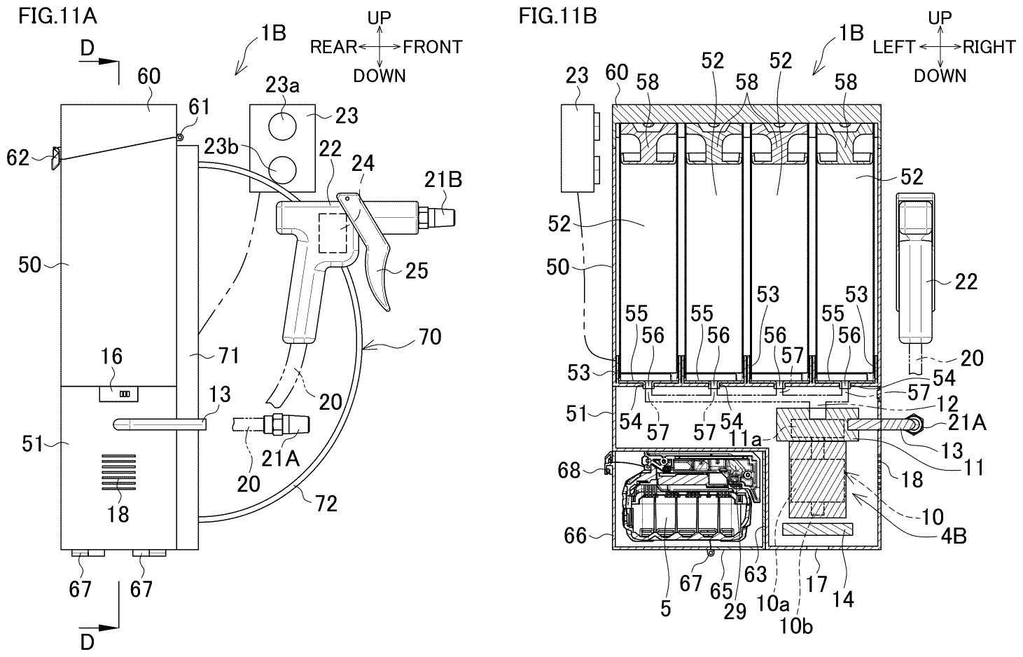

A grease discharge device 1B illustrated in FIG. 10 includes a cartridge housing tank, which is hereinafter referred to as a “housing tank”, 50 having a horizontally long rectangular shape in plan view on an upper side and a case 51 on a lower side. As illustrated in FIGS. 11A and 11B, four cartridges 52 are arranged in the right-left direction to be housed in the housing tank 50. Each cartridge 52 is filled with approximately 500 milliliters of grease. Accordingly, about two liters of grease can be stored in the housing tank 50. Four receiving rings 53 that project upward are arranged in the right-left direction to be formed on a bottom surface of the housing tank 50. Each cartridge 52 has a lower end gripped by each receiving ring 53 to be supported in the up-down direction. A through hole 54 is each formed at the center of each receiving ring 53 and in a bottom portion of the housing tank 50. The lower end of each cartridge 52 is sealed by a cushion rubber 55, and an outlet 56 provided at the center of the cushion rubber 55 penetrates the through hole 54 and projects into the case 51. Each outlet 56 is connected in the case 51 to each of four branch pipes 57 branched from the suction pipe 12. Each cartridge 52 has an upper end sealed by a rubber seal 58 to avoid air mixing.

A cartridge cover 60 is disposed at an upper portion of the housing tank 50. The cartridge cover 60 has a front surface rotatably joined to the housing tank 50 by a hinge 61. The cartridge cover 60 has a back surface on which a latch 62 configured to engage/disengage with the housing tank 50 is disposed such that the upper portion of the housing tank 50 can be arbitrarily opened and closed.

A pump unit 4B is housed in the case 51. The pump unit 4B is arranged on the right side of the case 51 and has the motor 10 at a lower part and the pump portion 11 at an upper part. The motor 10 is an inner rotor-type brushless motor as described in Embodiment 1. The fan 11a is disposed in the pump portion 11 at an upper portion of the motor 10. The four cartridges 52 are connected to the suction pipe 12 connected to the pump portion 11 via the respective branch pipes 57. The discharge pipe 13 is connected to the right side of the pump portion 11, penetrates a right side surface of the case 51, projects to the right side, and then, bends forward. The display part 16 is disposed on the upper side of the discharge pipe 13 and on the right side surface of the case 51. The controller 14 is arranged on the lower side of the motor 10. The air inlet 17 is formed below the controller 14 and on a bottom surface of the case 51, and the exhaust outlet 18 is formed on the right side of the motor 10 and on the right side surface of the case 51.

A cutout portion 63 is formed on the left side of the pump unit 4B and on the lower left side of the case 51. A battery base 65 is attached to the cutout portion 63 in a manner that fits exactly. The battery connector 29 is fixed to an upper surface of the battery base 65. A part of the battery base 65 is an opening and closing cover 66 into which respective parts of a left side surface, front and rear surfaces, and a lower surface of the battery base 65 are integrated. The opening and closing cover 66 has a lower surface joined to the battery base 65 by a hinge 67 and has a latch 68 on a left side surface, allowing the left side surface of the battery base 65 to be opened and closed by rotating around the hinge 67. The battery connector 29 is disposed sideways on an upper surface of the cutout portion 63. The battery pack 5 slides to be fitted to the battery connector 29 from the left side with the opening and closing cover 66 opened.

A harness 70 is disposed on a front surface of the grease discharge device 1B. The harness 70 includes a backrest portion 71 and a right and left pair of belts 72. The backrest portion 71 is attached to a front surface of the housing tank 50 and a front surface of the case 51 in a straddling manner. The belts 72 have upper and lower ends, each connected to the backrest portion 71 at the right and left of the backrest portion 71.

The grease discharge device 1B configured as described above allows an operator to carry the grease discharge device 1B on his/her back by putting both arms through the right and left belts 72 in a state where the cartridge 52 is housed in the housing tank 50 and the battery pack 5 is fitted to the battery connector 29 in the battery base 65. When the pressing operation of the ON button 23a of the switch 23 or the pushing operation of the trigger 25 is performed in a state where the coupler 21A or 21B is connected to a lubrication point of heavy machinery and the like, the controller 14 drives the motor 10. Then, the pump portion 11 of the pump unit 4B is activated to suction grease in each cartridge 52 via each branch pipe 57 from the suction pipe 12 and discharge the grease from the discharge pipe 13. The discharged grease is discharged from the coupler 21A or 21B via the flexible hose 20 and supplied to the lubrication point. When the pressing operation of the OFF button 23b of the switch 23 is performed or the pushing operation of the trigger 25 is released, the driving of the motor 10 is stopped to stop discharging the grease. The operator is in a state of carrying the grease discharge device 1B on his/her back and can, therefore, directly move to the next lubrication point.

When grease is supplied into the housing tank 50, it is only necessary to replace the cartridge 52 with the opening and closing cover 66 opened.

Thus, the grease discharge device 1B of the above-described Embodiment 2 includes the carrying-type housing tank 50, namely an exemplary tank, configured to store approximately two liters of grease, the pump unit 4B that suctions grease in the housing tank 50 and discharge the grease to an outside by driving of the motor 10, and an attachable and detachable battery pack 5 that drives the pump unit 4B.

With the configuration, a large grease storage amount can be secured by the carrying-type housing tank 50. In addition, since the motor 10 that activates the pump unit 4B is driven by the battery pack 5, a power supply cord and an air hose are not required, improving ease of handling and becoming less subject to the restriction of a work area. In particular, even when a lubrication point is positioned at a high location, the operator can carry the grease discharge device 1B on his/her back to the point and lubricate a lot of grease through the coupler 21A or 21B.

In addition, the grease discharge device 1B of the above-described Embodiment 2 includes the housing tank 50, namely an exemplary tank, which stores grease, the pump unit 4B connected to the housing tank 50, the motor 10 that drives the pump unit 4B, the battery pack 5 configured to supply electric power to the motor 10, and the trigger 25 that enables power feeding from the battery pack 5 to the motor 10 by predetermined operation and is separated from the pump unit 4B.

With the configuration, since the motor 10 that activates the pump unit 4B is driven by the battery pack 5, a power supply cord and an air hose are not required, improving ease of handling and becoming less subject to the restriction of a work area. In addition, since the trigger 25 separated from the pump unit 4B is operated to activate the pump unit 4B, an operator can easily control the grease supply and stop at hand.

The housing tank 50 is a back-carrying type including the harness 70 for back-carrying.

Accordingly, the grease discharge device 1B can be moved together with the operator.

The housing tank 50 houses the plurality of cartridges 52 filled with grease, and the pump unit 4B suctions the grease from the cartridges 52.

Accordingly, the supply and replenishment of grease to the housing tank 50 can be facilitated by the cartridges 52.

The housing tank 50 has a rectangular shape in plan view.

Accordingly, the housing tank 50 becomes easier to carry on a back, and a grease storage amount can be secured.

The pump unit 4B and the battery pack 5 are arranged at the lower portion of the housing tank 50.

Accordingly, the heavy housing tank 50 is positioned on the upper side, reducing the load on the operator. The supply and replenishment of grease can be facilitated from the upper side of the housing tank 50.

The following describes a modification example of Embodiment 2.

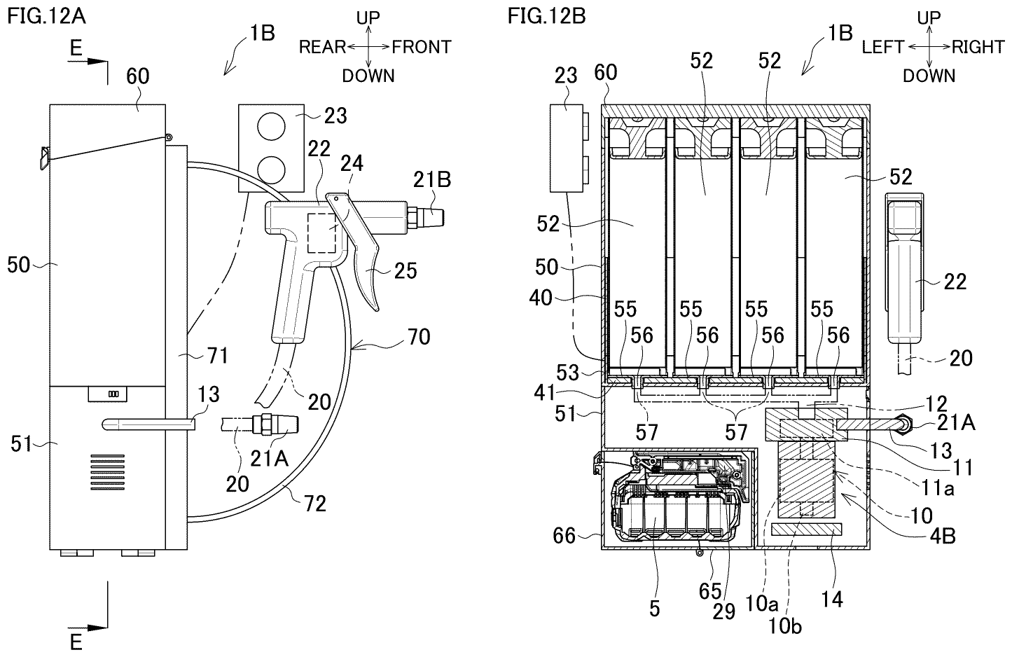

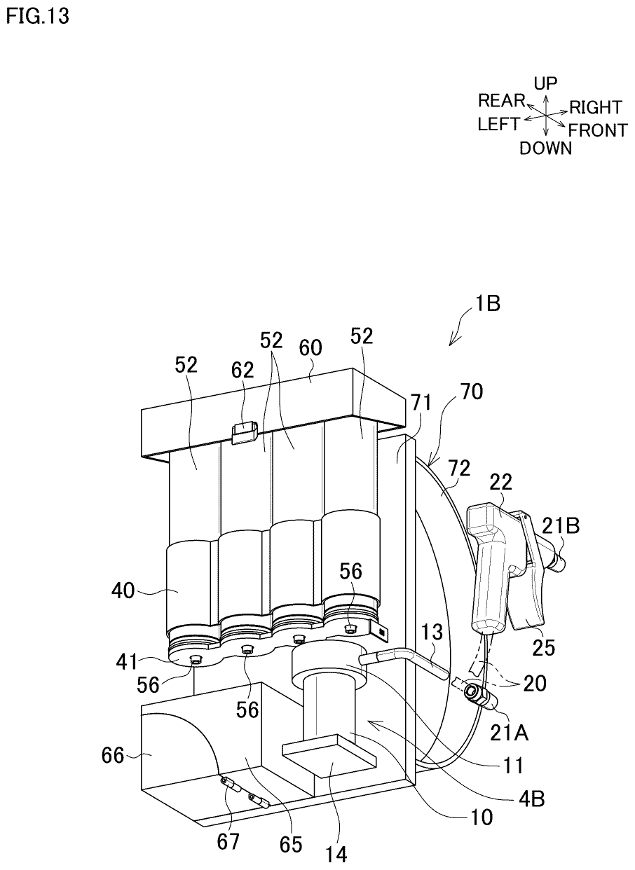

A heating unit for grease can be disposed even in the back-carrying type housing tank 50. FIGS. 12A and 12B and FIG. 13 illustrate the example.

Here, the strip-shaped first electric heater 40 that winds around four cartridges 52 are arranged on a peripheral area of the four cartridges 52 in the housing tank 50. In addition, the second electric heater 41 is arranged between the bottom surface of the housing tank 50 and the cushion rubber 55 of each cartridge 52, except for the outlet 56.

When the first and second electric heaters 40, 41 are thus disposed, each cartridge 52 can be heated from the outside to keep grease warm. Accordingly, since the grease does not become hard even when the temperature of a working environment is low, deterioration of workability due to poor discharge can be avoided.

Not both, but only any one of first and second electric heaters may be disposed. A configuration of the electric heater itself can be changed appropriately. The number of electric heaters may be increased to provide an electric heater per cartridge. The electric heater can also be disposed outside the tank.

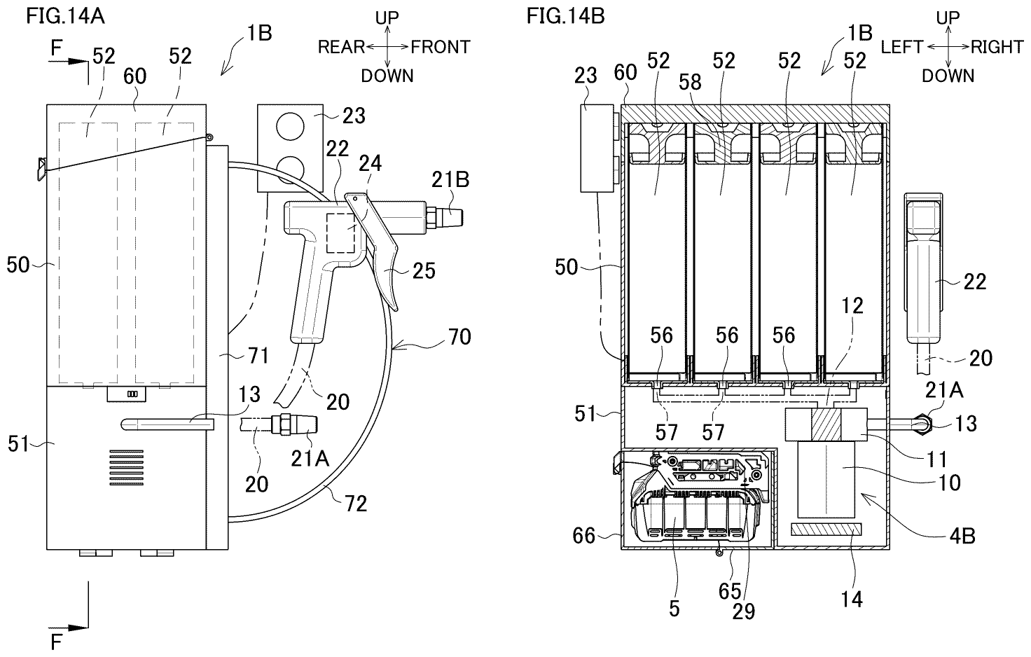

FIGS. 14A and 14B illustrate an example in which the number of cartridges 52 is eight in the grease discharge device 1B. The housing tank 50 is increased in front-rear width, and two rows of four cartridges 52 are disposed at the front and rear. The number of cartridges 52 is not limited to the example and can be increased and decreased appropriately. The array can also be changed appropriately. The shape and size of a cartridge are also not limited to the above-described example.

A harness is not limited to two right and left parallel belts, and, for example, cross-type belts that cross in front of the chest may be used. The length of the belts may be adjustable.

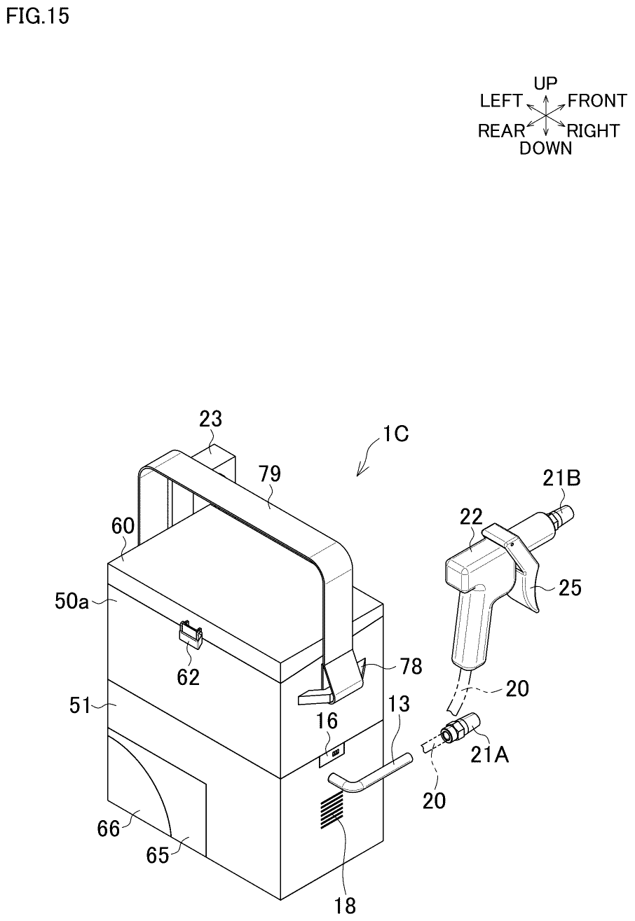

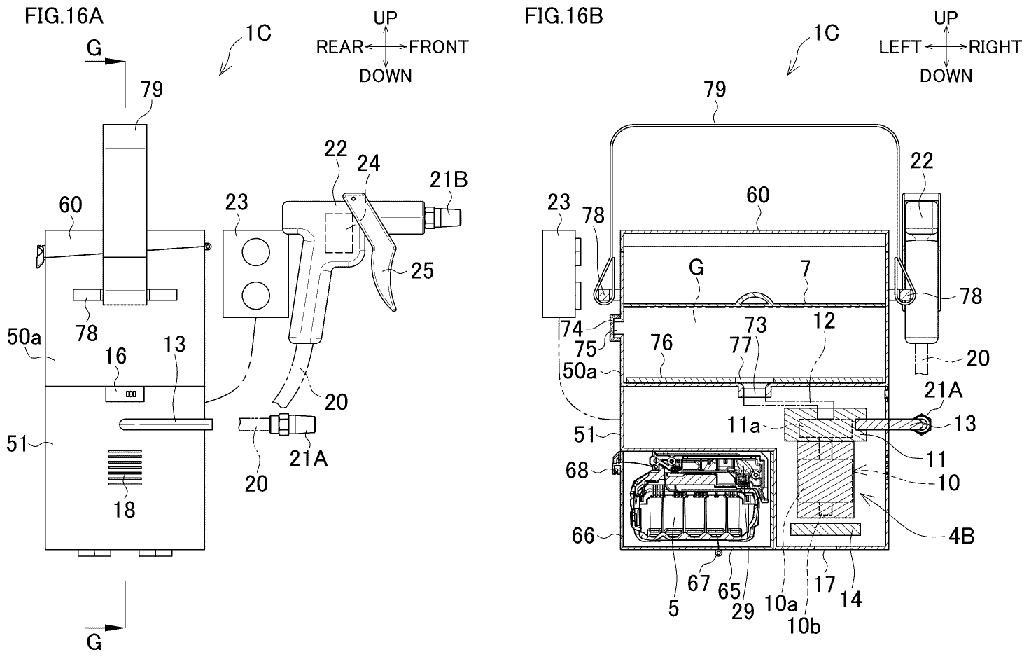

A configuration in which a cartridge is not housed in a tank may be employed. FIG. 15 and FIGS. 16A and 16B illustrate the example. In a grease discharge device 1C, the grease G can be stored directly inside a tank 50a. A storage amount is 3.4 liters. The inner lid 7 is disposed inside the tank 50a. An outlet 73 is formed at the center of a bottom surface of the tank 50a, and the suction pipe 12 is connected to the outlet 73. Here, grease is supplied directly into the tank 50a from above the tank 50a in a state where the cartridge cover 60 is opened and the inner lid 7 is removed.

A replenishing opening 75 sealed by a cap 74 in an ordinary state is disposed on a side surface of the tank 50a. A loader fitting that replenishes grease directly from a pail can or the like by removing the cap 74 can be attached to the replenishing opening 75. Thus, when the replenishing opening 75 is disposed and the loader fitting is attached, grease can be easily replenished without opening the cartridge cover 60. However, it is not necessary to have a replenishing opening.

FIGS. 16A and 16B also illustrate an example in which an electric heater 76 is disposed inside the tank 50a. The electric heater 76 has a square shape in plan view that is placed on the bottom surface of the tank 50a, and a through hole 77, which communicates the outlet 73 with the inside of the tank 50a, is formed at the center of the electric heater 76. The electric heater may be disposed on an internal surface of the tank 50a without limiting to the bottom surface of the tank 50a. The electric heater can also be disposed on an outer surface of the tank 50a.

FIG. 15 and FIGS. 16A and 16B also illustrate an example of a tank in which a shoulder belt 79 is disposed instead of a harness. Belt coupling portions 78 are disposed on right and left side surfaces of the tank 50a. Both ends of the shoulder belt 79, which crosses in the right-left direction above the tank 50a, are coupled to the belt coupling portions 78. Accordingly, the shoulder belt 79 allows an operator to carry the grease discharge device 1C on his/her shoulder and support it.

Thus, even when the tank 50a is a shoulder-carrying type that includes the shoulder belt 79, the grease discharge device 1C can be moved together with the operator.

It should be noted that a cartridge may be housed even in a shoulder-carrying type tank.

In common among the above Embodiment 2 and each modification example, the following changes can be made.

The configuration of a pump unit and the number of battery packs can be changed appropriately.

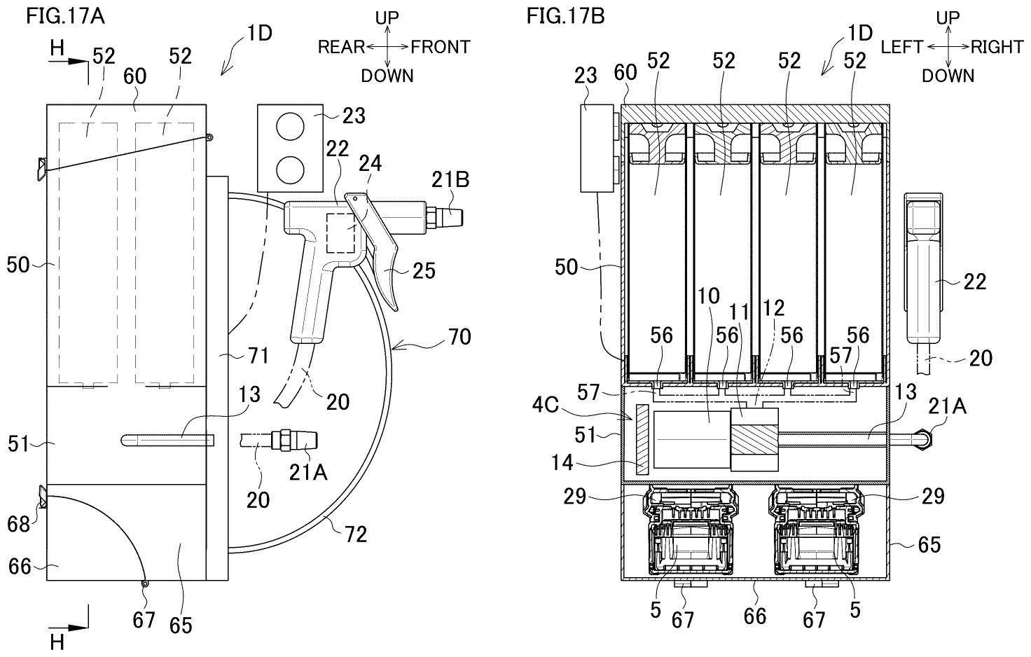

FIGS. 17A and 17B illustrate a pump unit 4C in which the motor 10, the pump portion 11, and the controller 14 are arranged in the right-left direction inside the case 51 in a grease discharge device 1D having the housing tank 50 that houses eight cartridges 52. The pump portion 11 is a plunger type and arranged at the center in the right-left direction on the upper side of the case 51. The motor 10 is arranged on the left side of the pump portion 11, and the controller 14 is arranged on the left side of the motor 10. In this case, the air inlet 17 (not illustrated) is disposed on a left side surface of the case 51 on the left side of the controller 14. The exhaust outlet 18 (not illustrated) is disposed on a rear surface of the case 51 at a rear of the motor 10. The display part 16 (not illustrated) is disposed on the left side surface of the case 51 and on the upper side of the air inlet 17.

FIGS. 17A and 17B also illustrate an example in which two battery packs 5 are disposed. The battery base 65 is formed long in the right-left direction on the lower side of the case 51 and has the opening and closing cover 66 into which respective parts of a rear surface, right and left side surfaces, and a lower surface of the battery base 65 are integrated. The opening and closing cover 66 has a lower surface coupled to the battery base 65 by the hinge 67 and has the latch 68 on a rear surface of the opening and closing cover 66, allowing the rear surface of the battery base 65 to be opened and closed. Two right and left battery connectors 29 are disposed on a lower surface of the case 51 inside the battery base 65, and the respective battery packs 5 slide to be fitted with the battery connectors 29 from the front.

Here, since the battery base 65 has a large front-rear width, the battery packs 5 can be housed in the front-rear direction with the battery connectors 29 oriented in the front-rear direction. When the battery base 65 has a large right-left width, the two battery packs 5 may be housed in a back-to-back manner by sliding to be fitted in the right-left direction from the right and left side surfaces. Three or more battery packs may be housed.

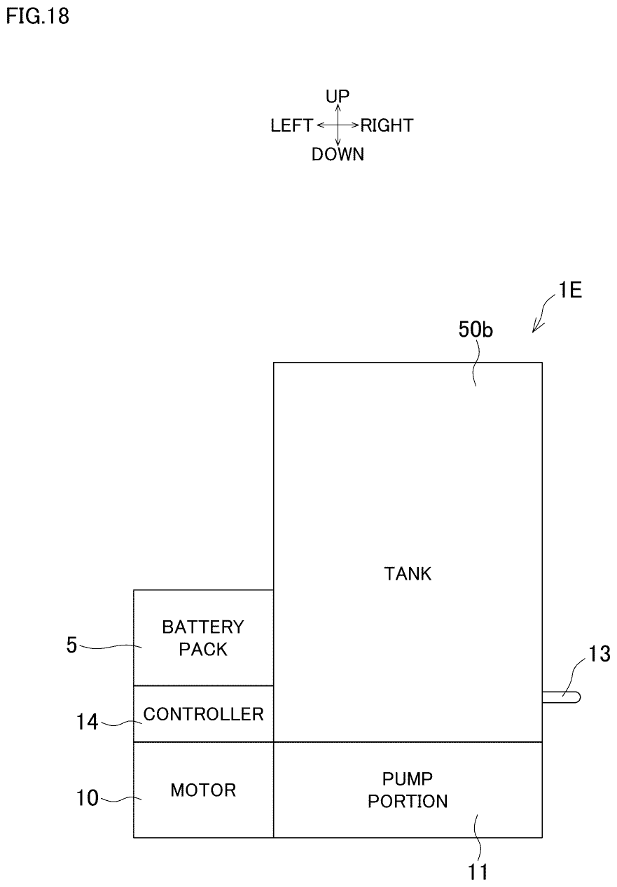

Another configuration, in which the plunger-type pump portion 11 is arranged on the lower side of a tank 50b, and the motor 10, the controller 14, and the battery pack 5 are arranged on the left side of the tank 50b, as in a grease discharge device 1E schematically illustrated in FIG. 18 is also considered as a layout of the pump unit and the battery with respect to the tank. This may be a left-right reversal. The pump portion 11 may be a plunger-type. The tank 50b may be a cartridge-housed type or a structure that stores grease directly and may be a back-carrying type or a shoulder-carrying type.

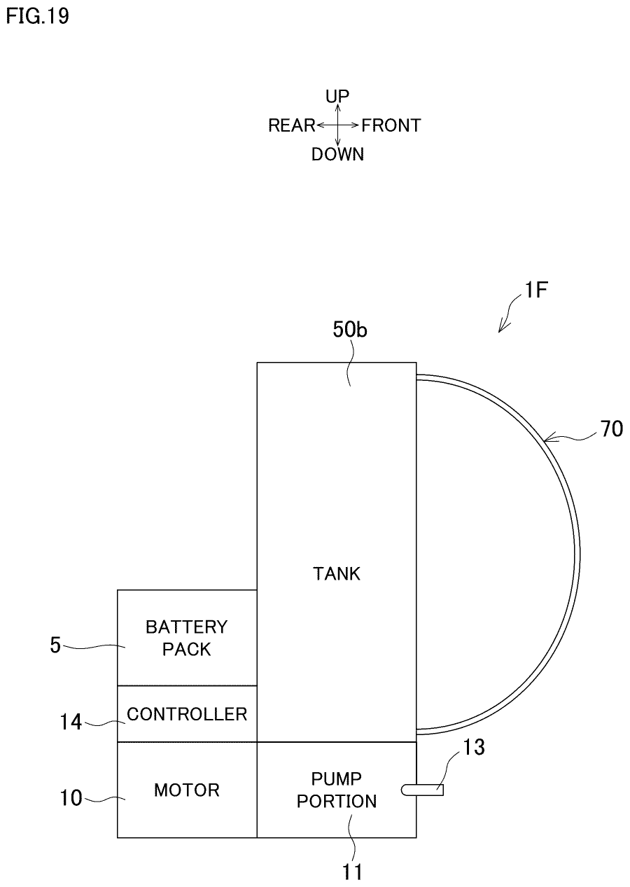

In addition, a configuration, in which the plunger-type pump portion 11 is arranged on the lower side of the tank 50b, and the motor 10, the controller 14, and the battery pack 5 are arranged on the rear side of the tank 50b, as in a grease discharge device IF schematically illustrated in FIG. 19 is also considered. In this case as well, the pump portion 11 may be a plunger-type. The tank 50b may be a cartridge-housed type or a structure that stores grease directly and may be a back-carrying type or a shoulder-carrying type.

The capacity of the tank is not limited to that of each example described above, and the tank can be used for a plurality of lubrication points as long as it allows at least one liter of grease to be supplied. The tank is not limited to having a square shape in plan view, but may have another shape, such as a circular shape in plan view, a semicircular shape in plan view, and an ellipse shape in plan view. The lid may be attachable and detachable without being joined by a hinge.

The discharge pipe may project from the left side of a case instead of the right side.

The speed change operation portion that changes the rotation speed of the motor is not limited to a trigger of a switch trigger. Another operation portion, such as a dial, may be disposed as a speed change operation portion. It is not necessary to have a speed change operation portion.

In each example described above, while the first coupler with the switch or the switch trigger is selectively connected, only any one of them may be connected.

The switches and the controller may be able to communicate wirelessly instead of by wire.

The battery is not limited to a battery pack for electric power tools. The configuration and the rated voltage may be changed appropriately.

The configuration of the battery base can also be changed appropriately. The battery base may be omitted.

The display part is not limited to displaying the remaining capacity of the battery but can display other information. For example, it is possible to display the amount of grease lubricated to the lubricating point from when the switch is turned on to when it is turned off. In addition, a sensor that detects the temperature and the storage amount of grease in the tank can be disposed to display the temperature and the remaining amount of the grease detected by the sensor.

The controller may be equipped with an AC/DC converter to allow a power supply cord to be connected such that the controller can be used with a commercial power source.

Then, a grease lubrication system according to a third configuration of the disclosure can be constructed. In the grease lubrication system, a battery pack is shared between a conventional portable grease discharge device that stores one liter or less of grease and the grease discharge device of the disclosure.

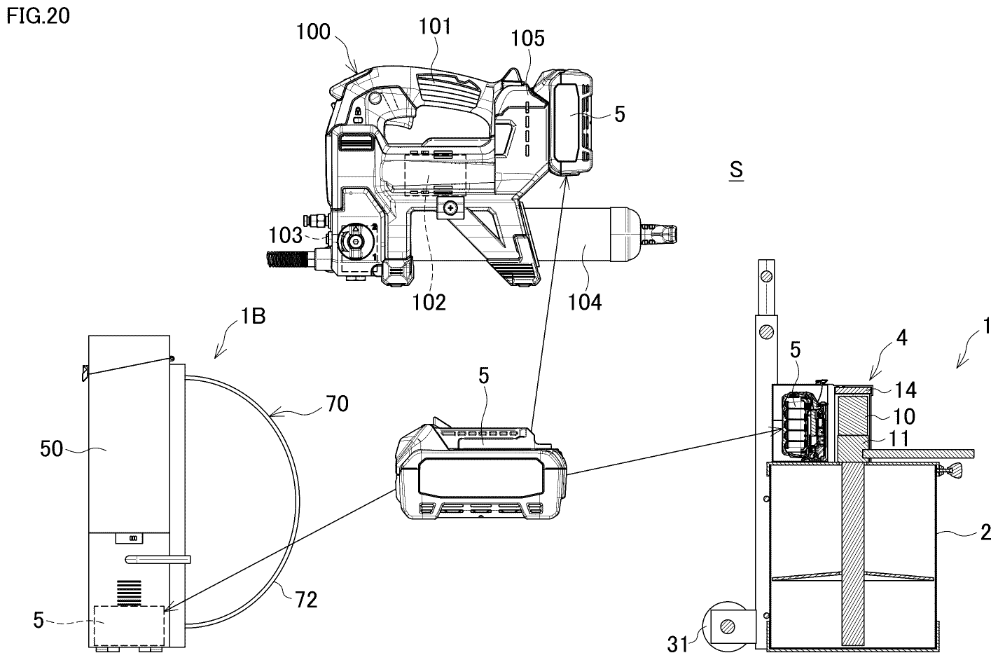

FIG. 20 illustrates an example of a grease lubrication system S, illustrating a grease gun 100 as the portable grease discharge device. The grease gun 100, namely an exemplary first grease discharge device, includes a housing 101 that has a motor 102, namely an exemplary first motor, and a plunger-type pump portion 103, namely an exemplary first pump portion, driven by the motor 102 and also includes a tank 104, namely an exemplary first tank, which houses a cartridge filled with one liter or less of grease. The battery pack 5 is fitted to a battery connector 105 disposed in the housing 101.

Accordingly, the grease lubrication system S, which includes the grease gun 100, for example, the grease discharge device 1 of Embodiment 1, namely an exemplary second grease discharge device, and one battery pack 5 that can feed power to the motor 102 and the motor 10, can be constructed. In this case, the tank 2 is an exemplary second tank, the motor 10 is an exemplary second motor, and the pump portion 11 is an exemplary second pump portion.

The grease lubrication system S allows proper uses, for example, use of the grease gun 100 fitted with the battery pack 5 in a narrow location where a tank cannot enter and use of the grease discharge device 1 fitted with the battery pack 5 in a relatively wide location with many lubricating points. Accordingly, the workability of lubrication work can be improved, and the number of battery packs used can be reduced.

A grounded-type grease discharge device may be that of another embodiment or modification example, or a carrying-type grease discharge device may be incorporated into a system to share a battery pack between a plurality of grease discharge devices of the disclosure and a grease gun. FIG. 20 also illustrates an example in which the grease discharge device 1B having the back-carrying type housing tank 50 illustrated in FIGS. 11A and 11B is incorporated into the system.

In addition, a system that shares a battery pack between a grease discharge device having a back-carrying type tank and a grease discharge device having a shoulder-carrying type tank is also considered.

In each system, a plurality of battery packs may be shared.

The following disclosures (1) to (14) can also be extracted from the content described above.
(1) A grease discharge device including:
a carrying-type tank configured to store at least one liter of grease;
a pump unit configured to suction the grease in the tank and discharge the grease to an outside by driving of a motor; and
an attachable and detachable battery that drives the pump unit.
(2) The grease discharge device according to (1),
in which the tank is a back-carrying type including a harness for back-carrying.
(3) The grease discharge device according to (1),
in which the tank is a shoulder-carrying type including a shoulder belt.
(4) The grease discharge device according to any one of (1) to (3),
in which the tank houses a plurality of cartridges filled with grease, and the pump unit suctions the grease from the cartridges.
(5) The grease discharge device according to any one of (1) to (3),
in which the tank includes a replenishing opening for replenishing grease.
(6) The grease discharge device according to any one of (1) to (5),
in which the tank has a rectangular shape in plan view.
(7) The grease discharge device according to any one of (1) to (6),
in which the pump unit and the battery are arranged at a lower portion of the tank.
(8) The grease discharge device according to any one of (1) to (7), further including
an operation portion that turns on or off the driving of the motor,
in which a discharge port of the pump unit is selectively connectable to a first coupler connectable to a grease supply destination, or a second coupler including a second operation portion that controls the motor and being connectable to a grease supply destination.
(9) The grease discharge device according to (8),
in which the second operation portion includes at least a switch that turns on or off the driving of the motor and an operating member that operates the switch.
(10) The grease discharge device according to (9),
in which the second operation portion includes a speed change operation portion configured to change a rotation speed of the motor.
(11) The grease discharge device according to any one of (1) to (10), further including
a display part that displays at least a remaining capacity of the battery.
(12) The grease discharge device according to any one of (1) to (11),
in which the battery is covered with a cover.
(13) The grease discharge device according to any one of (1) to (12),
in which a heating unit for grease is disposed on the tank.
(14) A grease discharge device including:
a tank that stores grease;
a pump unit connected to the tank;
a motor that drives the pump unit;
a battery configured to supply electric power to the motor; and
a trigger that enables power feeding from the battery to the motor by predetermined operation, the trigger separated from the pump unit.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A grease discharge device comprising:
a grounded-type tank configured to store grease with an opening at an upper part of the tank;
a lid that closes the opening;
a pump unit that is connected to the lid and configured to suction the grease in the tank and discharge the grease to an outside of the tank by driving of a motor; and
an attachable and detachable battery that drives the motor.

2. The grease discharge device according to claim 1, wherein
the battery is disposed on an upper surface of the lid.

3. The grease discharge device according to claim 1, wherein
a plurality of the batteries are disposed.

4. The grease discharge device according to claim 1, wherein
the tank includes a moving unit.

5. The grease discharge device according to claim 4, wherein
the moving unit has a tire.

6. The grease discharge device according to claim 5, wherein
the moving unit includes a handle.

7. The grease discharge device according to claim 6, wherein
the handle is adjustable in height.

8. The grease discharge device according to claim 4, wherein
the moving unit is a plurality of casters disposed on a bottom surface of the tank.

9. The grease discharge device according to claim 1, further comprising
an operation portion that turns on or off driving of the motor, wherein
a discharge port of the pump unit is selectively connectable to a first coupler connectable to a grease supply destination, or a second coupler including a second operation portion that controls the motor and being connectable to a grease supply destination.

10. The grease discharge device according to claim 9, wherein
the second operation portion includes at least a switch that turns on or off the driving of the motor and an operating member that operates the switch.

11. The grease discharge device according to claim 10, wherein
the second operation portion includes a speed change operation portion configured to change a rotation speed of the motor.

12. The grease discharge device according to claim 1, wherein
the tank is circular in plan view and has a capacity of at least 16 liters.

13. The grease discharge device according to claim 1, further comprising
a display part that displays at least a remaining capacity of the battery.

14. The grease discharge device according to claim 1, wherein
the battery is covered with a cover.

15. The grease discharge device according to claim 1, wherein
a heating unit for grease is disposed on the tank.

16. A grease discharge device comprising:
a grounded-type tank configured to store grease and having a capacity of 10 liters or more;
a pump unit configured to discharge the grease to an outside of the tank; and
an attachable and detachable battery that drives the pump unit.

17. A grease lubrication system comprising:
a first grease discharge device that includes a first tank configured to store one liter or less of grease and a first pump driven by a first motor to discharge the grease in the first tank;
a second grease discharge device that includes a second tank configured to store 10 liters or more of grease and a second pump driven by a second motor to discharge the grease in the second tank; and
a battery configured to feed power selectively to the first motor or the second motor.
